(19) United States
(12) Patent Application Publication
(10) Pub. No.: US 2009/0198725 A1
(43) Pub. Date: Aug. 6, 2009

(54) VISUALIZING TREE STRUCTURES WITH DIFFERENT EDGE LENGTHS

(75) Inventors: Bongshin Lee, Issaquah, WA (US); Lev Borisovich Nachmanson, Redmond, WA (US); George G. Robertson, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/119,498

(22) Filed: May 13, 2008

Related U.S. Application Data
(60) Provisional application No. 61/026,542, filed on Feb. 6, 2008.

(51) Int. Cl. G06F 17/30; G06F 3/048

(52) U.S. Cl. 707/102; 715/763; 707/E17.012

(57) ABSTRACT

A system described herein includes a receiver component that receives multiple data elements, wherein each of the data elements has a common attribute, and wherein the several data elements are hierarchically related. The system may further include an assignor component that independently assigns each of the multiple data elements to one of a plurality of layers, wherein a data element is assigned to a layer based at least in part upon a value of the common attribute that corresponds to the data element. The system may also include a renderer component that receives assignments made by the assignor component and graphically renders a tree structure based at least in part upon the assignments. Furthermore, a color bar can be generated that includes one or more rows based at least in part upon content of the tree structure.

### RELATED APPLICATION

This application claims priority to U.S. Provisional Patent Application No. 61/026,542, filed on Feb. 6, 2008, and entitled VISUALIZING EVOLUTIONARY TREES. The entirety of this application is incorporated herein by reference.

### BACKGROUND

Tree structures have been used in connection with visualizing data in various settings. For instance, humans have drawn family trees to illustrate who is related to whom. In another example, trees can be used to visualize a hierarchy of a company. Furthermore, HIV/AIDS researchers conventionally use machine learning techniques to identify how the human immune system influences the evolution of HIV within a human host. For instance, data can identify particular proteins in a human body as well as when an evolutionary event occurs with respect to the particular proteins. This evolutionary event may spawn another evolutionary event, and so on.

Conventionally, only relatively “small” trees have been visualized, since graphically illustrating a tree that has several hundred nodes, several thousand nodes, or even several million nodes would require a significant amount of display space. In many instances, however, tree structures do, in fact, include a large number of nodes. In a conventional mechanism for visualizing relatively large tree structures, a small portion of the tree structure is presented to a user and the user can then pan to view a portion of the tree structure that is desirably visualized. This conventional mechanism, however, may not provide the user with desired information pertaining to the tree structure, and the user may experience angst if unable to quickly obtain knowledge regarding the data underlying the tree structure.

### SUMMARY

The following is a brief summary of subject matter that is described in greater detail herein. This summary is not intended to be limiting as to the scope of the claims.

Described herein are various technologies relating to graphically rendering tree structures. Data elements may represent hierarchically related items/objects, such as individuals, proteins, etc. In a particular data set, each of the data elements may have a common attribute. For instance, each of the data elements in the data set may represent an individual, and a common attribute for the individual may be an age of the individual prior to the individual having a child.

Each of the data elements in the data set may be assigned to a layer based at least in part upon a value of the common attribute. For instance, a plurality of layers can be created in computer memory, wherein each layer may represent a range of values. Therefore, for instance, a first layer may correspond to a range of values between 2.00 and 3.00, and a value of a common attribute for a data element may be 2.5. Accordingly, the data element may be assigned to the first layer. In another example, a data element may be selected to be a root node in a tree structure, and data elements that are beneath the root node in the hierarchy can be assigned to a layer based at least in part upon a “distance” of the data elements from the root node.

A tree structure may be generated based at least in part upon the data elements and relationships therebetween. For instance, the tree structure may include nodes that are representative of the data elements and edges that interconnect the nodes. The edges may represent relationships between the data elements, and the length of the edges may be based at least in part upon the assignments of data elements to layers. For instance, a first data element may be represented by a first node, and a second data element may be represented by a second node that is a child of the first node. Accordingly, an edge may couple the first node and the second node, and a length of the edge may be indicative of, for instance, a distance in time between the first data element and the second data element. The tree structure may be graphically rendered on a graphical user interface.

Other aspects will be appreciated upon reading and understanding the attached figures and description.

### BRIEF DESCRIPTION OF THE DRAWINGS

FIG. 1 is a functional block diagram of an example system that facilitates graphically rendering a tree structure.

FIG. 2 is a functional block diagram of an example renderer component.

FIG. 3 is a graphical illustration of assignment of data elements to layers.

FIG. 4 is a functional block diagram of an example system that facilitates graphically rendering a color bar in connection with a tree structure.

FIG. 5 is a functional block diagram of an example bar renderer component.

FIG. 6 is a graphical depiction of rendering of a color bar.

FIG. 7 is a flow diagram illustrating an example methodology for graphically rendering a tree structure.

FIG. 8 is a functional block diagram of an example methodology for rendering a tree structure with a user-selected root node.

FIG. 9 is a functional block diagram of an example methodology for generating a color bar.

FIG. 10 is a functional block diagram of an example methodology for emphasizing a node that has been searched for by a user.

FIG. 11 is an example graphical user interface that can be used to depict a tree structure.

FIGS. 12-25 are screen shots of example graphical user interfaces.

FIG. 26 is an example computing system.

### DETAILED DESCRIPTION

Various technologies pertaining to graphically rendering tree structures, such as evolutionary trees, will now be described with reference to the drawings, where like reference numerals represent like elements throughout. In addition, several functional block diagrams of example systems are illustrated and described herein for purposes of explanation; however, it is to be understood that functionality that is described as being carried out by certain system components may be performed by multiple components. Similarly, for instance, a component may be configured to perform functionality that is described as being carried out by multiple components.

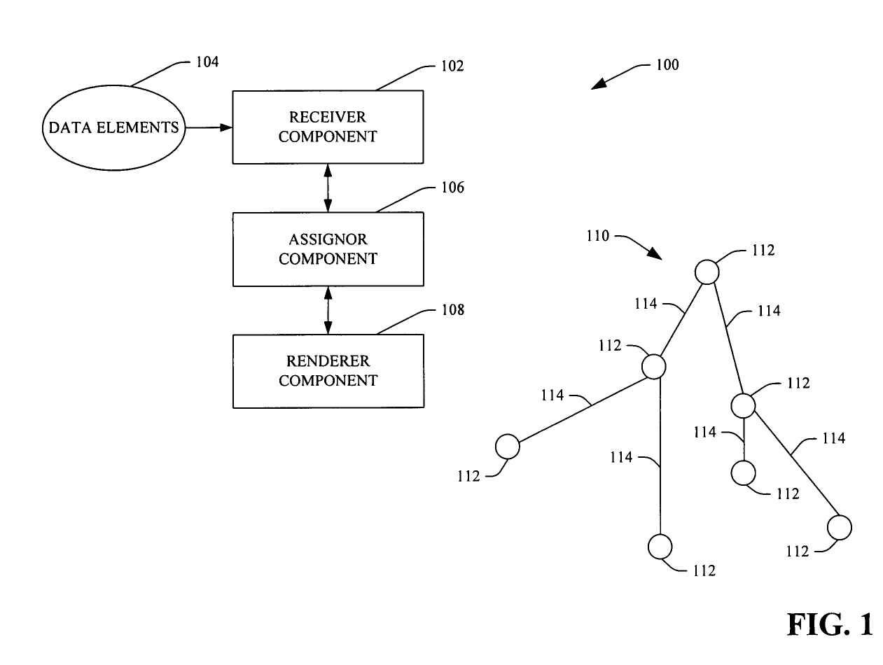

With reference to FIG. 1, an example system 100 that facilitates rendering a tree structure on a graphical user interface is illustrated. The system 100 includes a receiver component 102 that receives multiple data elements 104. In an example, the data elements 104 may be representative of individuals, evolutionary events, decisions in a decision tree, etc. Data elements in the data elements 104 may be hierarchically related. For instance, the data elements may be at least a portion of an evolutionary hierarchy. Furthermore, each data element in the several data elements 104 may have a common attribute. Pursuant to an example, the common attribute may be an amount of time between evolutionary events, a probability corresponding to an occurrence of an event, an age of an individual represented by a data element, or other suitable attribute. Moreover, each data element may have a value for the common attribute, wherein a value of the attribute for a first data element may be independent of a value of the attribute for a second data element. In a particular example, the data elements 104 may be included in a tree file, such as a tree file formatted in accordance with a Newick tree format.

The system 100 can further include an assignor component 106 that receives data elements from the receiver component 102 and individually assigns each data element in the multiple data elements 104 to one of a plurality of layers, wherein a data element is assigned to a layer based at least in part upon a value of the common attribute that corresponds to the data element. For instance, a first layer may correspond to a first range of values, a second layer may correspond to a second range of values, a third layer may correspond to a third range of values, and so forth. Furthermore, the first range of values may be adjacent to the second range of values, the second range of values may be adjacent to the third range of values, etc. Pursuant to a particular example, the Sugiyama scheme or a variation thereof may be used to assign data elements to a plurality of layers.

A renderer component 108 may receive assignments (made by the assignor component 106) and can graphically render a tree structure 110 based at least in part upon the assignments. The tree structure 110 can include nodes 112 that are representative of data elements in the multiple data elements 104. The tree structure 110 can further include edges 114 that are representative of relationships between data elements. Moreover, length of an edge in the tree structure 110 as rendered by the render component 108 can be based at least in part upon an assignment of a data element corresponding to the edge to a layer in the plurality of layers. As such, the length of the edge may be based at least in part upon a value of the common attribute. Still further, edges in the tree structure 110 may be at least partially curved in nature to facilitate display of an aesthetically pleasing tree structure.

Pursuant to an example, the multiple data elements 104 may be representative of evolutionary data. Accordingly, the data elements 104 may represent entities (e.g., an individual or individuals) and/or evolutionary events, and the common attribute may be an amount of time between evolutionary events, for example. Thus, a first node in the tree structure 110 can represent a first evolutionary event (e.g., a change of a particular gene), and a second node in the tree structure 110 can represent a second evolutionary event (e.g., a change in another gene), and an edge between the nodes can represent a time between the first and second evolutionary events.

In another example, the multiple data elements 104 may be representative of decision nodes in a decision tree, which can be represented by nodes in the tree structure 110. An edge between nodes may be representative of a probability that a particular decision will be made at an adjacent decision node. Thus, an individual viewing the tree structure 110 may be able to visually ascertain which routes in a decision tree are most probable and least probable.

In yet another example, the multiple data elements 104 may be representative of individuals, and the common attribute may be an age of the individuals at the time of their death (or current age for living individuals). An edge between two nodes may represent an age of an individual (represented by the first node) and a number of offspring of the individual. In still yet another example, the multiple data elements 104 (and thus nodes in the tree structure 110) may be representative of individuals, and the common attribute may be an age of the individual when they had children. In another example, the common attribute may be a current worth of an individual. Therefore, from viewing the tree structure 110 a person could quickly visually ascertain who in a family has obtained relatively more and less wealth. From the above examples it can be ascertained that the common attribute can be any suitable attribute that has some variability in value that, when represented visually, can provide a viewer of the tree structure 110 with knowledge relating to a node and/or relationships between nodes.

The renderer component 108 can be configured to render the tree structure 110 on a graphical user interface that may be displayed on a computing device, such as a personal computer, a personal digital assistant, a laptop computer, a portable telephone, or other suitable device. As will be described in greater detail below, various fields that facilitate gleaning information from the tree structure 110 can be included in the graphical user interface.

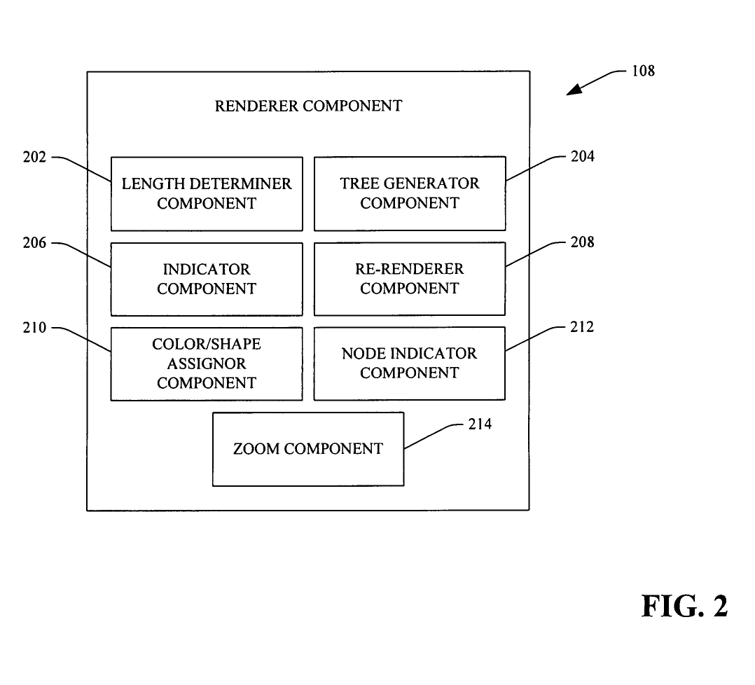

Referring now to FIG. 2, an example depiction of the renderer component 108 is illustrated. While the renderer component 108 is illustrated as including certain components that will be described as performing particular actions, it is to be understood that the renderer component 108 may include more or fewer components than what is shown. Additionally, functionality described as being performed by one component may be performed by a combination of components. Further, an illustrated component may perform additional functionality than what is described.

The renderer component 108 may include a length determiner component 202 that can determine length of edges in a tree structure (e.g., the tree structure 110) based at least in part upon an assignment of one or more data elements to one or more layers and/or a value of the common attribute. The length determiner component 202 may set a minimum edge length and/or a maximum edge length to facilitate displaying a tree structure such that an individual can glean information from viewing the tree structure. More particularly, setting a minimum edge length may be helpful in connection with differentiating between nodes in a tree structure. Similarly, setting a maximum length may allow numerous nodes and edges to be displayed to a user on a graphical user interface.

The renderer component 108 may further include a tree generator component 204 that can graphically generate the tree structure. For instance, the tree generator component 204 can determine where on a display apparatus nodes are to be rendered based at least in part upon edge lengths determined by the length determiner component 202. Furthermore, the tree generator component 204 can select a node in the tree structure to be the root node and can output a tree structure accordingly. The tree generator component 204, for instance, may select a data element that has a particular value with respect to the common attribute to be the root node. In another example, the tree generator component 204 may select a data element to be the root node that has a highest or lowest value with respect to the common attribute when compared to other data elements. For instance, in an evolutionary tree, a root node can be automatically selected that corresponds to an earliest point in time (e.g., an earliest evolutionary event).

The renderer component 108 may also include an indicator component 206 that receives a user selection of a second attribute (different from the common attribute) and can indicate on the tree structure which nodes correspond to the second attribute. For instance, the tree structure may be an evolutionary tree, wherein nodes represent evolutionary events and/or individuals and edges represent an amount of time between evolutionary events. A user may select a particular attribute, such as a certain protein, from amongst a displayed list of attributes. Upon receipt of the selection, the indicator component 206 can indicate which nodes (e.g., leaf nodes) that have the certain protein. Furthermore, the indicator component 206 can visually emphasize at least one edge that is coupled to nodes that have the certain protein. The indicator component 206 can indicate nodes in the tree that have the selected attribute by, for example, rendering such nodes in a bolder color. In another example, the indicator component 206 can indicate nodes in the tree that have the selected attribute by rendering nodes that do not have the selected attribute more transparently when compared to nodes that have the selected attribute. Other manners of visually indicating which nodes have the selected attribute are contemplated and intended to fall under the scope of the hereto-appended claims.

The renderer component 108 may also include a re-renderer component 208 that receives a selection of a node in the tree structure that is desired by a user to be set as the root node and re-renders the tree structure based at least in part upon the selection. For instance, a user may wish to view a tree structure with a different node as the root node, and can select a node in a graphically rendered tree structure to act as the root node. Upon receiving the user selection, the re-renderer component 208 can re-render the tree structure with the selected node as the root node. Length of edges between nodes may be based at least in part upon length of edges determined by the length determiner component 202.

In addition, the renderer component 108 may include a color/shape assignor component 210 that assigns colors to nodes in the tree structure based at least in part upon values of attributes corresponding to the nodes. Pursuant to an example, leaf nodes in a tree structure may be human beings that are from various locations. The color/shape assignor component 210 can assign a first color and/or shape to nodes that represent individuals from a first location, assign a second color and/or shape to nodes that represent individuals from a second location, assign a third color and/or shape to nodes that represent individuals from a third location, and so forth. Thus, for a certain node, a value of a particular attribute can cause the node to be assigned a certain color and/or shape, such that when displayed on a graphical user interface, a user will be able to quickly ascertain the value of the attribute based at least in part upon the color and/or shape of the node. Furthermore, the color and/or shape assignor component 210 can assign colors and/or shapes to edges that correspond to nodes to further emphasize the value of the attribute corresponding to the node. For example, the color/shape assignor component 210 can assign a color and/or shape to a leaf node and can assign a substantially similar or same color to an edge that couples the leaf node to another node. The renderer component 108 can graphically render the tree structure such that nodes and edges of the tree structure are colored in accordance with colors assigned thereto by the color assignor component 210. While assignment of a particular color and/or shape for attributes has been described above, it is to be understood that a color can be assigned to a first attribute and a shape can be assigned to a second attribute. For instance, a color can be assigned based upon a location of an individual and a shape can be assigned based upon a gender of the individual.

The renderer component 108 may also include a node indicator component 212 that can visually indicate nodes that are selected (e.g., by a pointing and clicking mechanism) by a user. For instance, a user may select a data element in a list of data elements that are displayed on a graphical user interface. A node corresponding to the selected data element may be automatically emphasized upon the user selecting the data element. For instance, the node may be temporarily highlighted in the tree structure by, for instance, increasing size of the node, rendering the node as being bold, changing shape of the node, placing a highlighted ring around the node, and/or the like. Thus, if a user can locate a data element (e.g., a node) in a list of data elements, the user will be able to quickly ascertain where the node is located in the tree structure.

Still further, the renderer component 108 may include a zoom component 214 that can be used to alter zoom levels of the tree structure. For instance, a user can employ a dragging mechanism (known as a marquee selection using a mouse, a touch-sensitive display, a static pad, etc.) to select an area they would like to view more closely (e.g., a particular grouping of nodes). Once such area is selected, the zoom component 214 can be used to “zoom in” on the selected area. Furthermore, the zoom component 214 may be used to “zoom out” in order to provide a user with a different view of the tree structure.

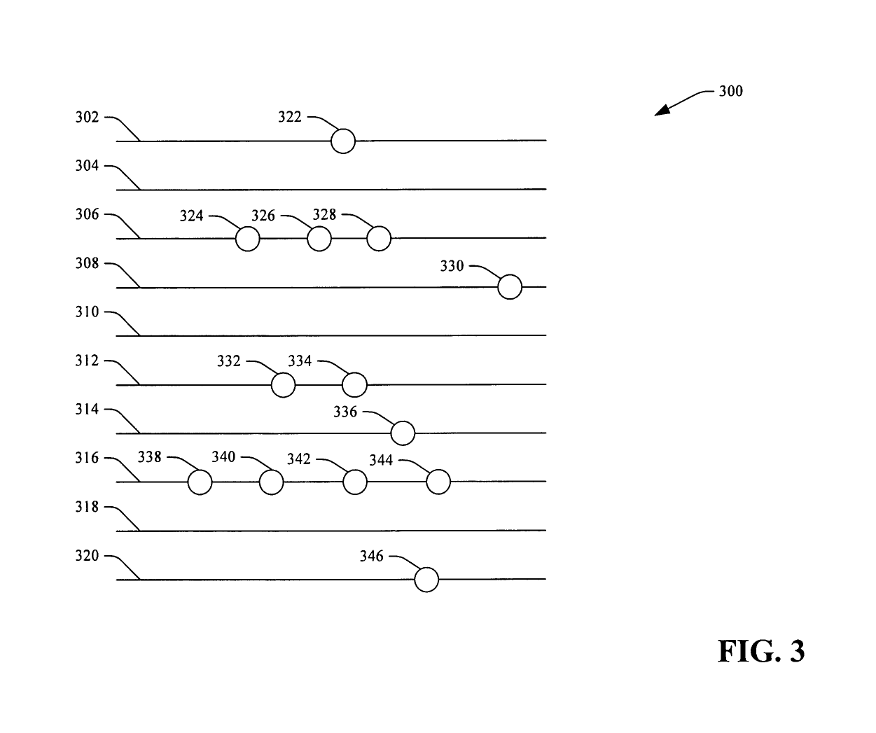

Now referring to FIG. 3, an example depiction 300 of data elements being individually assigned to one of a plurality of layers is provided. More particularly, ten different layers 302, 304, 306, 308, 310, 312, 314, 316, 318, and 320 are depicted. Each of the layers may correspond to a particular range of values, wherein ranges of values of adjacent layers are also adjacent. For instance, the first layer 302 may correspond to a range of values between zero and up to an including one, the second layer 304 may correspond to a range of values between one and up to including two, the third layer 306 may correspond to a range of values between two and up to and including three, and so forth. Continuing with the example, thirteen data elements 322, 324, 326, 328, 330, 332, 334, 336, 338, 340, 342, 344, and 346 may be desirably individually assigned to one of a plurality of the layers 302-320. As discussed above, each of the attributes (with the possible exception of an element that will be a root node) can have a common attribute, wherein the data elements 322-346 have different values assigned thereto.

For example, the first data element 322 may be desirably set as a root node in a tree structure, and thus the common attribute may have a value of zero or may not be assigned a value. Accordingly, the first data element 322 can be assigned to the first layer 302. Each of the other data elements 324-346 may be children of the first data element 322. It is to be understood, however, that a tree may be a binary tree, such that each node has at most two children. In another example, each node may have any suitable number of nodes. The second data element 324 may have a value for the common attribute of 2.3, the third data element 326 may have a value for the common attribute of 2.5, and the fourth data element 328 may have a value for the common attribute of 2.7. Accordingly, the second, third, and fourth data elements 324-328 may be assigned to the third layer 306. The fifth data element 330 may have a value for the common attribute of 3.3, and thus may be assigned to the fourth layer 308. For the sake of brevity, assignments of the data elements 332-346 are not fully described. As can be ascertained from FIG. 3, the sixth and seventh data elements 332 and 334 have been assigned to the sixth layer 312, the eighth data element 336 has been assigned to the seventh layer 314, the ninth, tenth, eleventh, and twelfth data elements 338, 340, 342, and 344 have been assigned to the eighth layer 316, and the thirteenth data element 346 have been assigned to the tenth layer 320.

Based at least in part upon the assignment of data elements to layers, lengths of edges in a tree structure representing relationships between data elements can be determined, and a tree structure with edges of the determined lengths can be rendered. As noted above, the first data element 322 may be used as a root node in the tree. Nodes that represent data elements 324, 326, and 328 can be assigned to a substantially similar layer (306) because length of edges between nodes that represent such elements and a node that represents the first data element 322 may be substantially similar. A fifth node that represents the fifth data element 330 may be assigned to the layer 308, since an edge length between the fifth node and the first node is longer than edge lengths between the nodes that represent that data elements 324, 326, and 328 and the first node. For sake of brevity, determining layers for remaining data elements 332-346 is not described; however, one can discern from the above examples how layers can be determined based upon edge lengths corresponding to data elements.

While the above example has been described with the first data element 322 corresponding to a root node, and the other data elements 324-346 to children of the root node, it is to be understood that assignment of data elements to layers can be used in connection with rendering edges between numerous tiers of nodes. For instance, the second, third, and fourth data elements 324-328 may be represented in a tree structure as children of the first data element 322. However, the fourth and fifth data elements 330 and 332 may be desirably represented as children of the second data element 324, and the sixth 334 data element and seventh data element 346 may be desirably represented as children of the third data element 326. Accordingly, rendering of edges on a graphical user interface can be based at least in part upon assigning data elements to layers. As noted above, the Sugiyama approach or a variation thereof can be used to assign data elements to layers based at least in part upon a “distance” of data elements from a data element that is desirably represented as a root node—however, it is to be understood that any suitable layer assignment technique may be employed.

More specifically, the Sugiyama scheme has been used in connection with acyclic graphs. Nodes can be organized into horizontal layers in such a way that each edge of a graph goes down at least one layer—accordingly, source nodes (e.g., a root node) can be positioned at top layers and sinks can be positioned at bottom layers. The original Sugiyama scheme can be modified to locate layers based upon edge lengths. For instance, m can be a minimum edge length. For each node v of a tree, d(v) can be a length of a path from the tree root to a node, which can be a sum of edge lengths on the path. The integer l(v)=floor(d(v)/m) can provide a layer of the node (vertex) v, where floor(p) can be a maximal integer that is at least as small as p, such that floor(0.9)=0. Accordingly, nodes u and v can be assigned to a same layer if l(u)=l(v). Since m can be a minimum edge length,

$$\frac{d ( v )}{m} - \frac{d ( u )}{m} = \frac{d ( u ) + n}{m} - \frac{d ( u )}{m} = \frac{n}{m} \geq 1 ,$$

where n is the length of edge (u, v). Accordingly,

$$floor ( \frac{d ( v )}{m} ) - floor ( \frac{d ( u )}{m} ) \geq 1.$$

Therefore, l(v)−l(u)≧1 for every edge (u, v) of the tree structure. Accordingly, every edge goes at least one layer “down”.

Further, the standard Sugiyama scheme reduces edge crossings by ordering nodes inside of the layers. This step can be avoided due to the existence of a tree. Nodes can be naturally ordered, preserving the order of children in received data elements (e.g., in a received tree file), such that for every two siblings belonging to a same layer, every node in between can also be labeled as a sibling. After such a layer calculation, Y-coordinates of the nodes can be known; such coordinates can be determined based upon length of paths from the root. The order of the nodes within layers can also be known. To find X-coordinates, any suitable alignment method can be used, and splines can be drawn. As noted, however, other mechanisms for determining layers and drawing tree structures are contemplated.

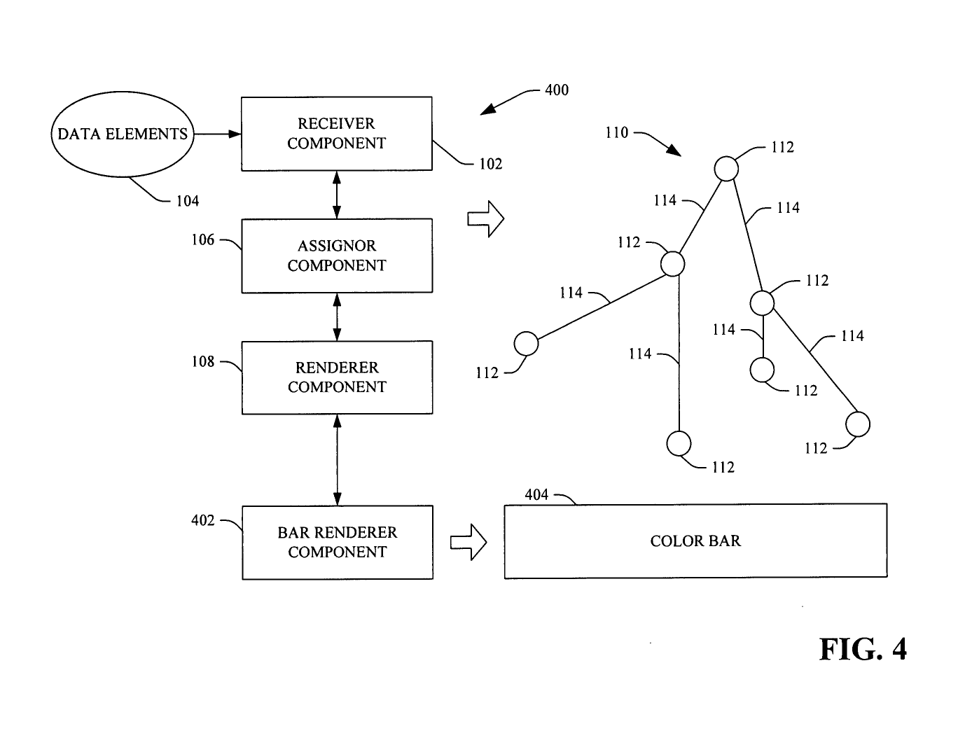

With reference now to FIG. 4, an example system 400 that facilitates rendering a tree structure and a color bar that corresponds to the tree structure on a graphical user interface is illustrated. The system 400 includes the receiver component 102, the assignor component 106, and the renderer component 108 which can act in conjunction as described above to render the tree structure 110. More particularly, the renderer component 108 can render the tree structure 110 such that nodes (e.g., leaf nodes) in the tree structure 110 are assigned a color based at least in part upon values of an attribute corresponding to the leaf nodes.

The system 400 may further include a bar renderer component 402 that can graphically render a color bar 404 on a graphical user interface together with the tree structure 110. As will be described in greater detail below, the bar renderer component 402 can generate the color bar 404 such that the color bar 404 includes a plurality of rows or columns, wherein each row or column of the color 404 bar corresponds to a different attribute. Pursuant to an example, a first row of the color bar 404 can be reflective of assigned colors of nodes (e.g., leaf nodes) in the tree structure 110. Thus, for instance, each leaf node of the tree structure 110 can be represented in the first row of the color bar 404. A second row of the color bar 404 may correspond to a first particular attribute, such that portions of the second row are “colored” if a node corresponding to the portion has a value for the particular attribute. Similarly, a third row of the color bar 404 may correspond to a second particular attribute, such that portions of the second row are colored if a node corresponding to the portion has a value for the second particular attribute. Accordingly, researchers or other individuals reviewing the tree structure 110 can quickly ascertain which portions of the tree structure have particular attributes. This may be particularly well-suited for genetic research, wherein a researcher can review the tree structure 110 and the color bar 404 and determine which portions of the tree structure have certain attributes, and can further determine whether attributes are related to one another. An example color bar and corresponding tree structure are described below.

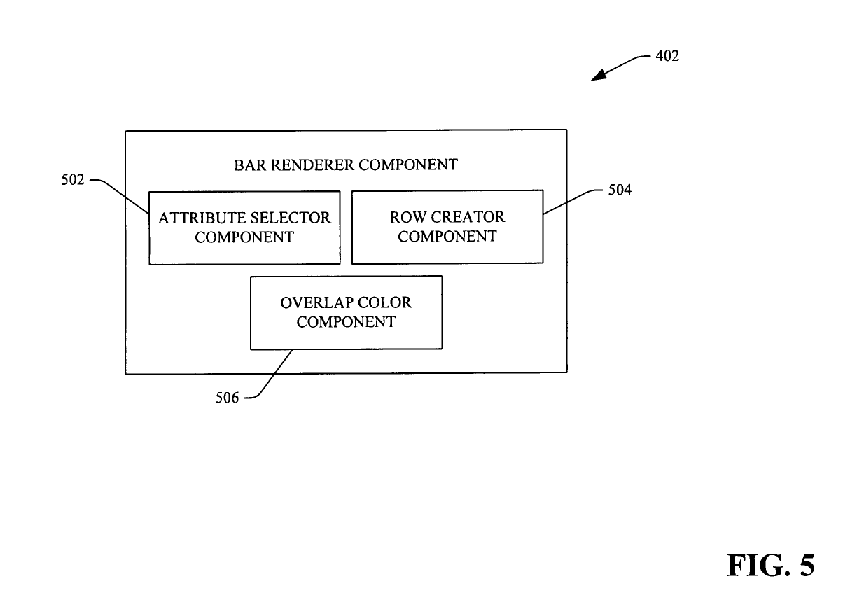

Turning now to FIG. 5, an example configuration of the bar renderer component 402 is depicted. The bar renderer component 402 may include an attribute selector component 502 that can receive user selections of attributes that are desirably used when rendering a color bar corresponding to a tree structure. A row creator component 504 can create a row in the color bar that corresponds to a selected attribute or attributes. Pursuant to an example, a graphical user interface may include a list of selectable attributes, wherein a user can select one or more attributes by way of, for instance, selecting a check box, moving a slider, selecting text, voice commands, or the like. In a detailed example, the attributes may be a list of proteins that may be found in some individuals DNA, and a tree structure may include nodes that represent individuals. The nodes may be assigned a color based upon location of the individuals (e.g., green for the United States, blue for Great Britain, red for Japan, . . . ). Thus, a first row of the color bar can be indicative of clusters of individuals from a certain region. The attribute selector component 502 can receive a user selection of an attribute (e.g., a particular protein), and the row creator component 504 can create a row in the color bar that illustrates which individuals have values for the attribute (e.g., which individuals have the selected protein). A researcher, then, can quickly ascertain whether a location correlates to the selected protein and can quickly locate a branch or branches of the tree structure that correspond to the selected protein by reviewing the tree structure and the color bar.

The bar renderer component 402 may further include an overlap color component 506 that darkens shades of color in the color bar when nodes overlap. More particularly, in tree structure with numerous nodes, nodes may be positioned closely together such that it may be difficult to provide visual information pertaining to a single node or a collection of nodes. The overlap color component 506 can render portions in the color bar to be somewhat opaque, such that if nodes of a same color overlap then the color appears to be darker or bolder, and if nodes of different colors overlap then a resulting color is a mixture of the overlapping colors (e.g., if a red portion of the color bar overlaps with a blue portion of the color par, the overlapped portion may be rendered as purple). Overlapping of nodes may facilitate rendering tree structures with a large number of nodes and presenting information pertaining to the nodes in a color bar.

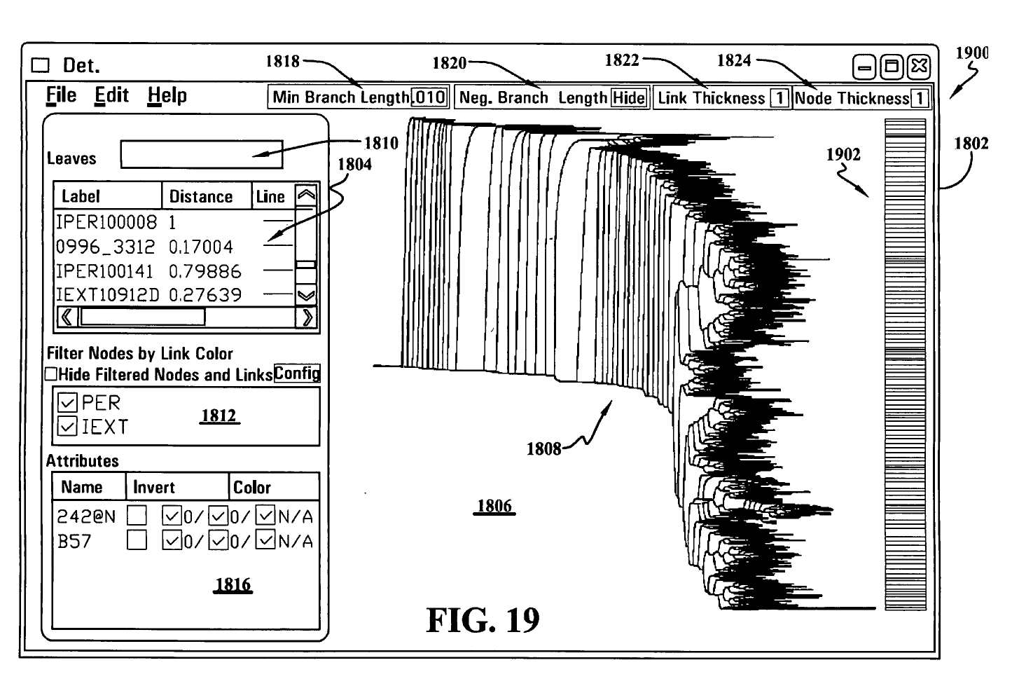

The description of the color bar above is based upon a tree laid out vertically (e.g., top to bottom). It is to be understood, however, that a tree can be laid out horizontally (e.g., left to right or right to left), and a color bar may be displayed vertically (e.g., to the right and/or to the left of a tree). In such a form, the row creator component 504 can arrange rows in the color bar vertically. FIG. 19 shows such an alternate layout embodiment.

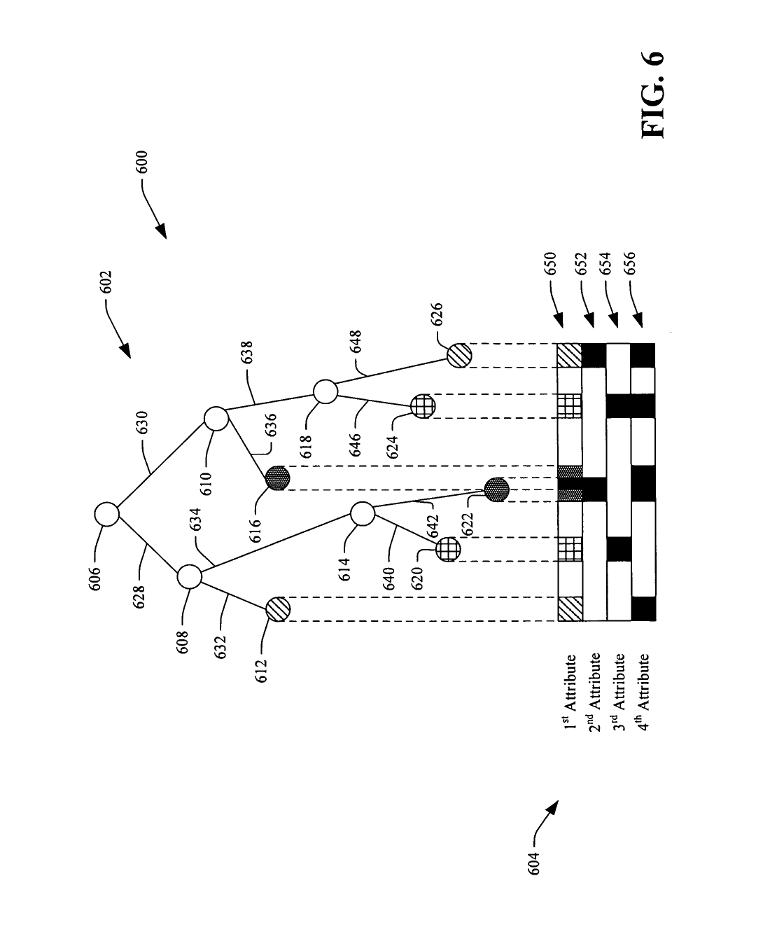

With reference now to FIG. 6, a depiction 600 of an example tree structure 602 and a corresponding color bar is 604 illustrated. The tree structure 602 includes a plurality of nodes 606, 608, 610, 612, 614, 616, 618, 620, 622, 624, and 626 and further includes edges 628, 630, 632, 634, 636, 638, 640, 642, 644, 646, and 648 that depict relationships between nodes (e.g., parent/child relationships). For example, the node 606 is a root node, and is coupled to nodes 608 and 610 (child nodes) by edges 628 and 630, respectively. As described above, lengths of the edges 628 and 630 (and edges 632-648) are based at least in part upon values of a common attribute with respect to the nodes 606-626.

In the example tree structure 602, the nodes 612, 616, 620, 622, 624, and 626 are leaf nodes (e.g., the nodes 612, 616, 620, 622, 624, and 626 have no children). Furthermore, the leaf nodes 612, 616, 620, 622, 624, and 626 can have different values for a first attribute. For instance, the leaf nodes 612 and 626 may have substantially similar value for the first attribute, the leaf nodes 620 and 624 may have a substantially similar value for the first attribute (but different than the value for the first attribute with respect to the leaf nodes 612 and 626), and the leaf nodes 616 and 622 may have a substantially similar value for the first attribute (but different than the values for the first attribute with respect to the leaf nodes 612, 620, 624, and 626). Leaf nodes can be assigned a color in the tree structure 602 based at least in part upon a value of the first attribute. Thus, leaf nodes 612 and 624 may be assigned a first color, leaf nodes 620 and 624 may be assigned a second color, and leaf nodes 616 and 622 may be assigned a third color. In a particular example, the leaf nodes may represent individuals, and the first attribute may be a country of residence of the individuals. Thus, individuals represented by the leaf nodes 620 and 624 may reside in a first country, individuals represented by the leaf nodes 612 and 626 may reside in a second country, and individuals represented by the leaf node 616 and 622 may reside in a third country.

The example color bar 604 can correspond with the example tree structure 602 in general, and can reflect which leaf nodes have particular attributes. More particularly, the color bar 604 is shown as including four rows 650, 652, 654, and 656 (although a color bar may include more or fewer rows). The first row 650 corresponds to the first attribute. For instance, as shown, colors assigned to the leaf nodes can be represented in the first row 650 of the color bar. It is to be noted that portions in the color bar corresponding to leaf nodes 616 and 622 overlap—where the portions overlap can be shown more boldly than other portions.

The second row 652 corresponds to a second attribute, wherein all leaf nodes may not have the second attribute or may not have a value corresponding to the second attribute. For instance, the leaf nodes 612, 616, 620, 622, 624, and 626 may represent individuals, and the second attribute may be a particular genetic trait that may be found in a subset of the individuals represented by the leaf nodes 612, 616, 620, 622, 624, and 626. In the example color bar 604, it can be discerned that individuals represented by the leaf nodes 622 and 626 have the particular genetic trait. The third row 654 corresponds to a third attribute, and as shown the leaf nodes 620 and 624 have the third attribute. Further, the fourth row 656 corresponds to a fourth attribute, and as illustrated leaf nodes 612, 616, 622, 624, and 626 have the fourth attribute.

While a row of the color bar 604 is shown as corresponding to a single attribute, it is to be understood that a row of the color bar may correspond to several attributes that are considered as a combination. For instance, an individual desirably reviewing the tree structure 602 and color bar 604 may wish to view a color bar that includes a row corresponding to two attributes (e.g., which individuals have a first genetic trait and a second genetic trait). Moreover, a number of rows in a color bar may depend on available display real estate on a display device as well as a number of attributes selected by a user. Furthermore, while the color bar 604 is shown as indicating which leaf nodes include selected attributes, it is to be understood that the color bar 604 may be configured to depict which nodes (including leaf nodes) include selected attributes.

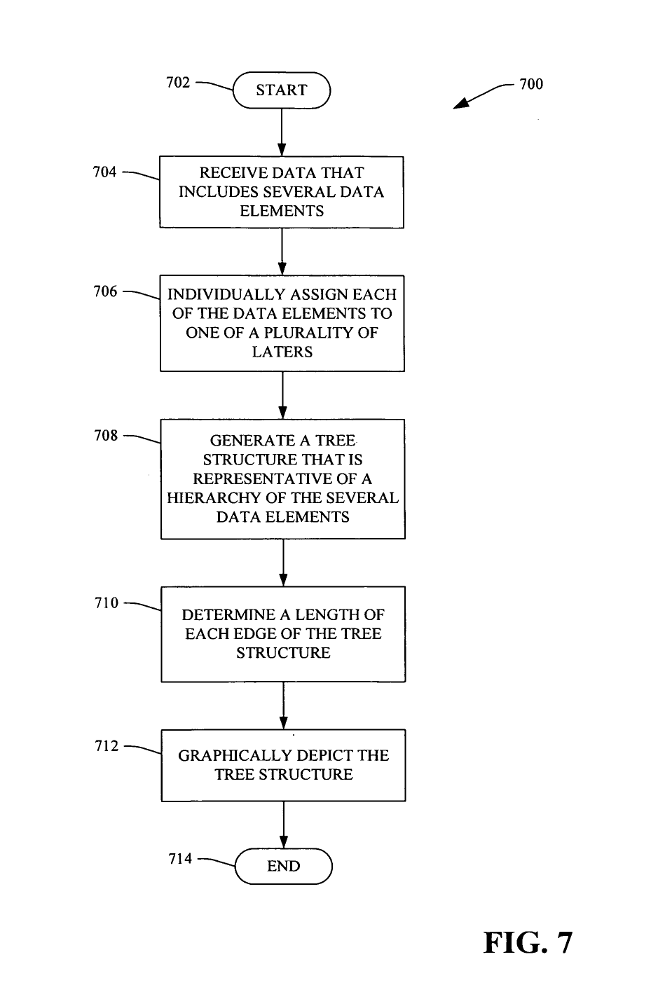

With reference now to FIGS. 7-10, various methodologies are illustrated and described. While the methodologies are described as being a series of acts that are performed in a sequence, it is to be understood that the methodology is not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be executed by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like.

Referring now to FIG. 7, a methodology 700 that facilitates graphically depicting a tree structure is illustrated. The methodology 700 starts at 702, and at 704 data is received, wherein the data includes several data elements. The data elements may be related hierarchically. For instance, the data elements may represent individuals in a family tree, evolutionary events separated by time, or any other suitable hierarchical data. The data elements in the received data may have a common attribute associated therewith, wherein each data element may have a value independently assigned thereto. Thus, a value for the attribute for a first data element may be different from a value for the attribute for a second data element.

At 706, each of the data elements may individually be assigned to one of a plurality of layers based at least in part upon the value of the common attribute for each of the data elements. Pursuant to an example, a first data element may desirably represent a root node in a tree structure, and the values of the common attribute may represent a “distance” from the root node. A second data element, a child of the first element, may be assigned to a layer based at least in part upon the “difference” in attribute values with respect to the first data element and the second data element.

At 708, a tree structure is generated that is representative of a hierarchal relationship of the data elements. The tree structure can include nodes that represent the data elements and edges that represent relationships between the data elements. Furthermore, the edges may correspond to the common attribute.

At 710, lengths of multiple edges are determined in the tree structure based at least in part upon assignments of data element (which correspond to nodes) to layers. Pursuant to an example, an edge can indicate a parent/child relationship between data elements, and a length of the edge may be representative of an amount of time between initial existence of the parent and initial existence of the child. Other examples are contemplated and intended to fall under the scope of the hereto-appended claims.

At 712, the tree structure is graphically depicted, wherein the tree structure includes edges with lengths determined at 710. Accordingly, one can view the tree structure and glean pertinent information relating to relationships amongst data elements. The methodology 700 completes at 714.

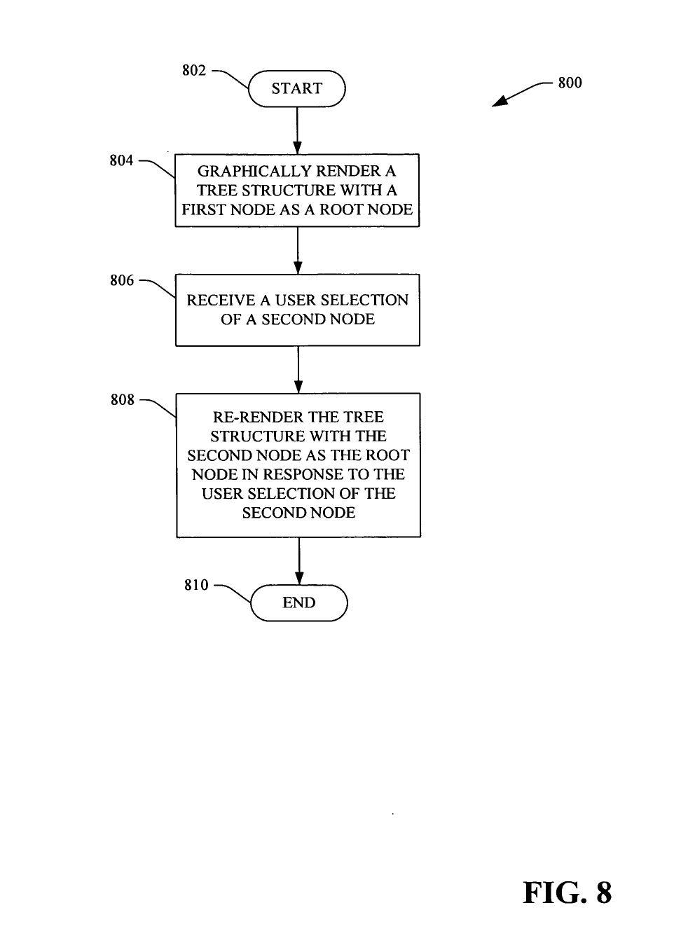

Referring now to FIG. 8, an example methodology 800 that facilitates rendering a tree structure with a user-selected node as a root node of the tree structure is illustrated. The methodology 800 starts at 802, and at 804 a tree structure is graphically rendered with a first node as a root node. In other words, as depicted in the tree structure, the root node has no parent node. Pursuant to an example, the first node may be selected as the root node automatically based upon a value of an attribute corresponding to a data element represented by the root node.

At 806, a user selection of a second node can be received. For instance, a user may select the second node with a pointing and clicking mechanism on the tree structure. In another example, a user may select the second node by selecting a data element in a list of data elements corresponding to the tree structure. In yet another example, the user may select the second node by way of voice command or any other suitable selection mechanism.

At 808, the tree structure is re-rendered with the second node as the root node in response to the user selection of the second node. Re-rendering of the tree structure may provide a user with a different perspective of relationships between data elements in the tree structure. The methodology 800 completes at 810.

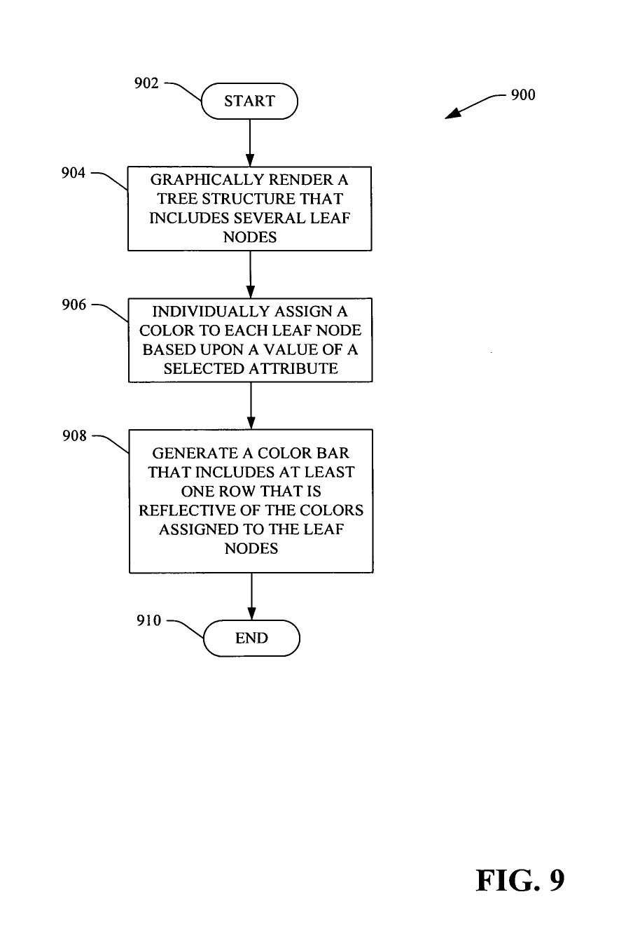

Turning now to FIG. 9, an example methodology 900 that facilitates generating a color bar that corresponds to a graphically rendered tree structure is illustrated. The methodology 900 starts at 902, and at 904 a tree structure is graphically rendered that includes several leaf nodes (e.g., nodes with no children). At 906, colors are individually assigned to leaf nodes based at least in part upon values of one or more attributes that correspond to the leaf nodes. Examples of assigning colors to nodes have been provided above. At 908, a color bar is generated that at includes at least one row that is reflective of the colors that are assigned to the leaf nodes. The methodology 900 completes at 910.

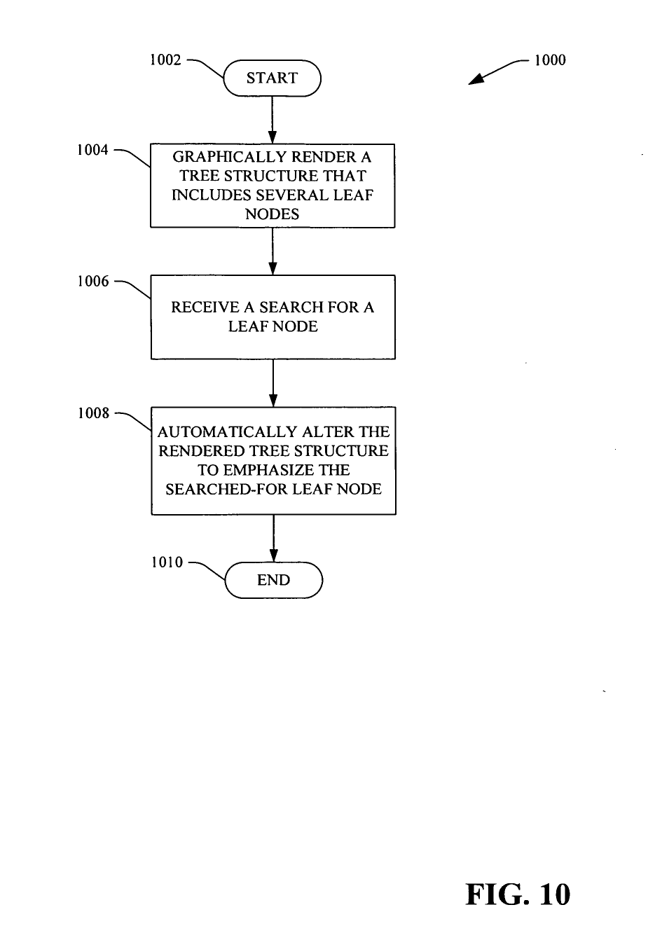

With reference to FIG. 10, an example methodology 1000 that facilitates locating a particular node in a tree structure is illustrated. The methodology 1000 starts at 1002, and at 1004 a tree structure is graphically rendered that includes several leaf nodes. At 1006, a search is received for a leaf node. For instance, a graphical user interface may include a search field that can be used to receive queries from a user, and nodes (e.g., data elements represented by nodes) can be searched over using the queries. In another example, a graphical user interface may include a list of data elements represented by nodes (e.g., in alphanumerical order) and a user can search such list and select a data element. Upon the search being performed, at 1008 the rendering of the tree structure is altered to temporarily emphasize the leaf node that was the subject of the search to aid a user in locating the leaf node that corresponds to the data element. To emphasize the leaf node, a shape of the leaf node may be changed, the leaf node may be rendered in a particular color, the perspective of the tree structure can be changed (e.g., a “zoom in” can be automatically performed to emphasize the leaf node that is the subject of the search). The methodology 1000 completes at 1010.

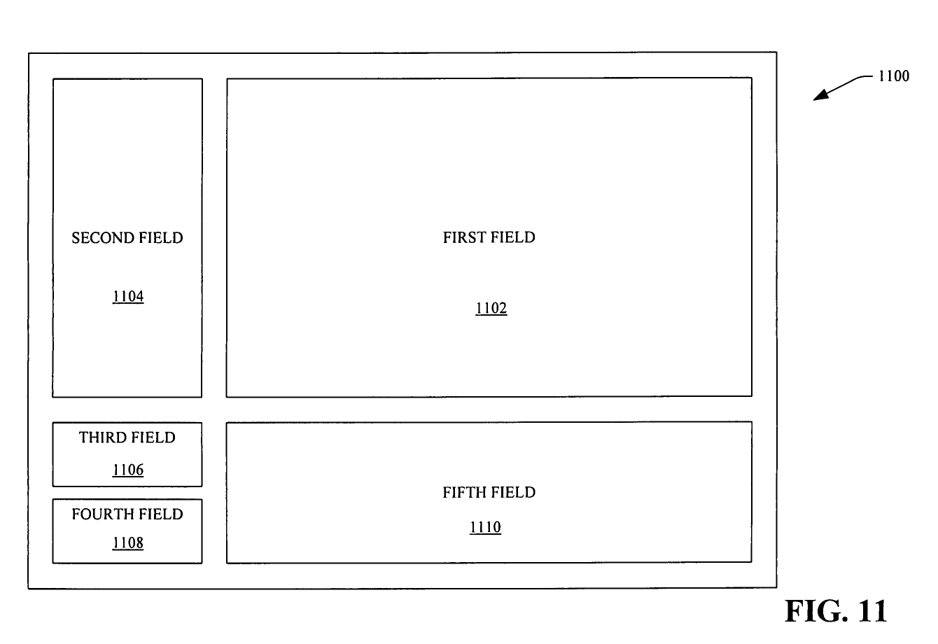

With reference to FIG. 11, an example graphical user interface 1100 that can depict a tree structure, corresponding color bar, and other information is illustrated. The graphical user interface 1100 includes a first field 1102 that can display a hierarchical tree structure. A displayed tree structure may include nodes that are representative of data elements and edges that are representative of relationships between data elements (e.g., parent/child relationships). As noted above, length of edges in the tree structure may be based at least in part upon values of a common attribute for the data elements.

A second field 1104 can be used to display of listing of data elements represented by nodes in the tree structure, wherein the listing of data elements may include a plurality of selectable data elements. Pursuant to an example, upon a user selecting a data element in the listing of data elements, a node (and/or one or more edges) corresponding to the selected data element can be emphasized.

The graphical user interface 1100 may also include a third field 1106 that can display a listing of possible values for an attribute that is common amongst data elements represented in the tree structure. Each of the values may be selectable. Pursuant to an example, upon selection of a value of the common attribute, nodes that correspond to data elements that have the selected value for the common attribute can be emphasized. Conversely, de-selection of a value of the common attribute in the listing of selectable values can de-emphasize nodes in the tree structure that represent data elements that have the selected value of the common attribute. In an example, nodes may correspond to individuals, and the common attribute may be country of residence of the individuals. The selectable values, then, may be different countries.

Furthermore, the graphical user interface 1100 may include a fourth field 1108 that can include a plurality of selectable attributes, wherein each of the selectable attributes corresponds to a subset of data elements represented in the tree structure. A fifth field 1110 may be included in the graphical user interface 1100, and can display a color bar. Contents of the color bar can be based at least in part upon which attributes in the plurality of selectable attributes have been selected. For instance, colors may be assigned to nodes in the tree structure. Data elements that are represented by nodes in the tree structure that have a selectable attribute can be represented in the color bar (e.g., a portion in the color bar corresponding to the data element may have a color that is substantially similar to that assigned to the node that represents the data element). In another example, the color bar may be displayed in the first field 1102 together with the tree structure.

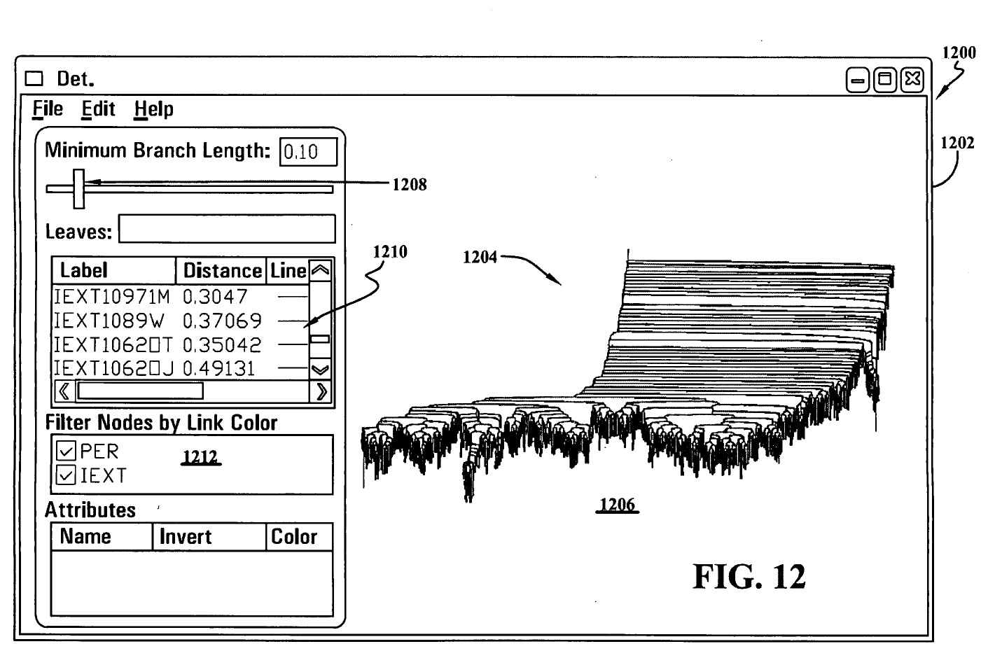

Now referring to FIG. 12, a screenshot 1200 that depicts an example graphical user interface 1202 that can be used to display a tree structure 1204 is illustrated. The graphical user interface 1202 includes a first field 1206 that includes a rendering of the tree structure 1204. As discussed above, the tree structure 1204 includes a plurality of nodes that represent data elements and edges that represent relationships between the data elements. Length of an edge in the tree structure 1204 is indicative of a value (e.g., numerical value) of an attribute that is common amongst the data elements. Thus, lengths of different edges in the tree structure 1204 may be different.

The graphical user interface 1202 may include a slide bar 1208 that facilitates user-selection of a minimum length of edges in the tree structure 1204. For instance, if an edge length is very small, it may be difficult to visually discern a difference between nodes. In another example, the graphical user interface 1202 may include a field that facilitates user-entry of a minimum edge length, wherein a user may use numeric keys to select a desired minimum edge length.

The graphical user interface 1202 may further include a second field 1210 that comprises a listing of data elements that are represented in the tree structure 1204. Information that can be displayed in the second field 1210 can include, but is not limited to a name or label of a data element, a “distance” between the data element and another data element (e.g., distance between the data element and a data element represented by a root node), a color assigned to a node that represents the data element, annotations for the data element, and the like. The second field 1210 may include scroll bars that can be used to scroll through information depicted in the field 1210.

The graphical user interface 1202 may also include a third field 1212 that includes a listing of selectable values for a common attribute. As discussed above, one example of a common attribute may be country of residence. Any suitable attribute that can have multiple values, however, can be depicted in the third field 1212. For instance, selection of a particular value may act to filter data elements based upon whether or not the data elements correspond to the particular value. Moreover, a node in the tree structure 1204 may be assigned a color based at least in part upon a value of the common attribute with respect to a data element that is represented by the node.

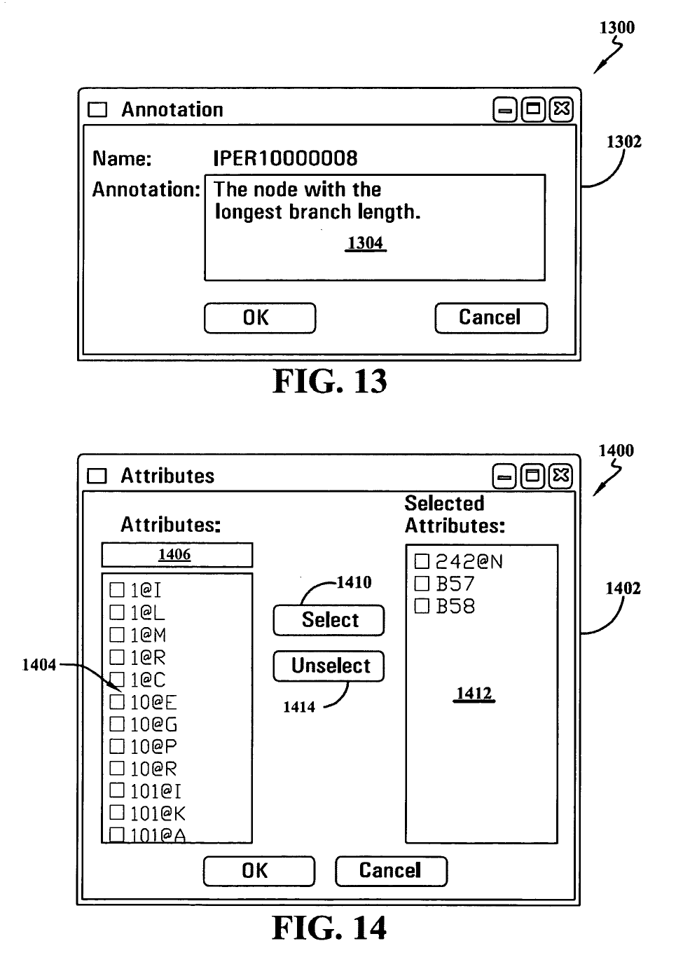

Now referring to FIG. 13, a screenshot 1300 of an example graphical user interface 1302 is illustrated, wherein the graphical user interface 1302 may be used to annotate a data element represented by a node in a tree structure. The graphical user interface 1302 may include a first field 1304, wherein a user can enter annotations for a selected data element into the first field 1304. Such annotations can be saved and associated with the data element until altered by a user.

With reference to FIG. 14, a screenshot 1400 of an example graphical user interface 1402 that can be used in connection with selecting attributes for employment in connection with generating a color bar is illustrated. The graphical user interface 1402 includes a first field 1404 that includes a plurality of selectable attributes, wherein an attribute in the plurality of selectable attributes corresponds to a subset of data elements represented by nodes in the tree structure. The attributes may be selected by using a scroll bar to locate an attribute and thereafter selecting a check-box corresponding to the attribute. Additionally or alternatively, a search field 1406 can receive a query and an attribute can be located based at least in part upon the received query. The graphical user interface 1402 may further include a depressible select button 1410. A second field 1412 can be populated with selected attributes upon depression of the select button 1410. An unselect button 1414 can be used to transition attributes in the second field 1412 to the first field 1404.

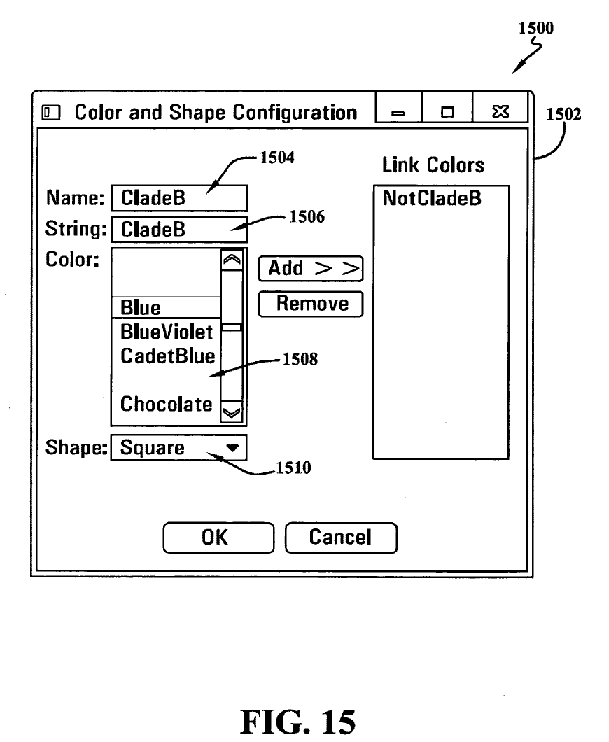

Turning now to FIG. 15, a screenshot 1500 of an example graphical user interface 1502 is depicted. The graphical user interface 1502 facilitates configuration of color and/or shape of nodes in a tree structure based at least in part upon node labels (e.g., nodes with certain attributes). The graphical user interface 1502 may include a field 1504 that can be used to select a name of a node, and may further include a field 1506 that can be used to select a string of a node. A field 1508 can include numerous selectable colors, such that nodes with the selected name and/or string can be assigned a selected color. A pull-down menu 1510 can be used to assign a shape to nodes with the selected name and/or string.

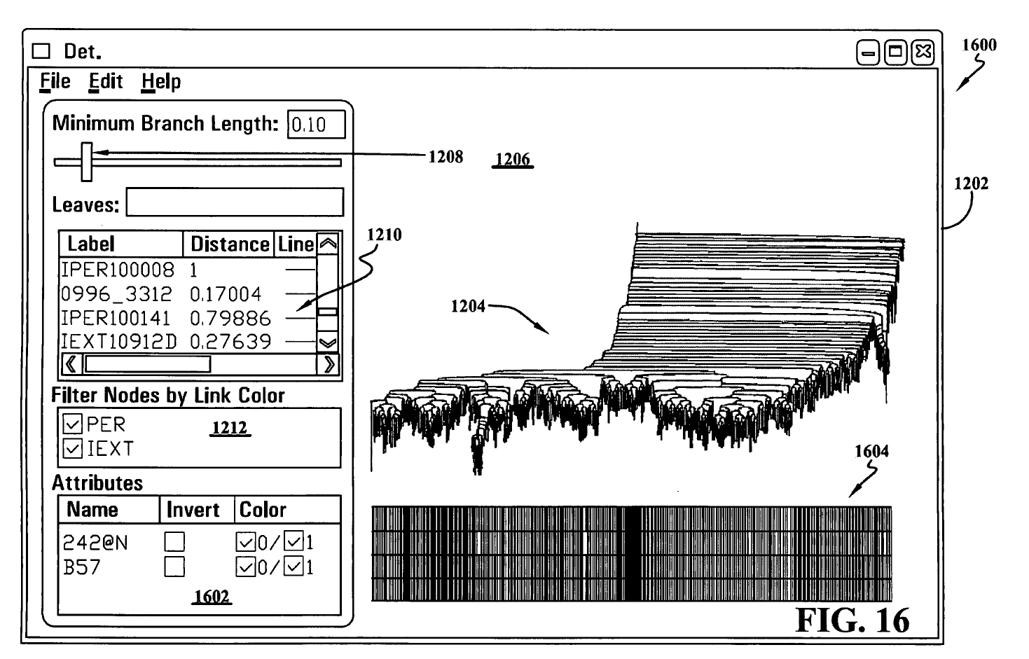

Now referring to FIG. 16, a screenshot 1600 of the example graphical user interface 1202 is illustrated. The graphical user interface 1202 includes a fourth field 1602 that can receive user selections of attributes (e.g., attributes selected by way of the user interface 1402) that can be used in connection with rendering the tree structure 1204 and/or a color bar 1604 that corresponds to the tree structure 1204. Pursuant to a particular example, the color bar 1604 may include a row for each attribute displayed in the fourth field 1602 (e.g., three rows) as well as a row that is reflective of colors of nodes in the tree structure.

In an example, each attribute depicted in the fourth field 1602 may be selectable by a user, and a row in the color bar 1604 may be rendered in response to selection of an attribute. For instance, a row in the color bar can be reflective of which nodes (e.g., leaf nodes) have the selected attribute. In another example, at least two possible values can be displayed in connection with an attribute, and different colors can be assigned to the at least two possible values. Therefore, if a value is selected, portions in the color bar that correspond to nodes in the tree structure that correspond to the selected value will be assigned a color corresponding to the selected value.

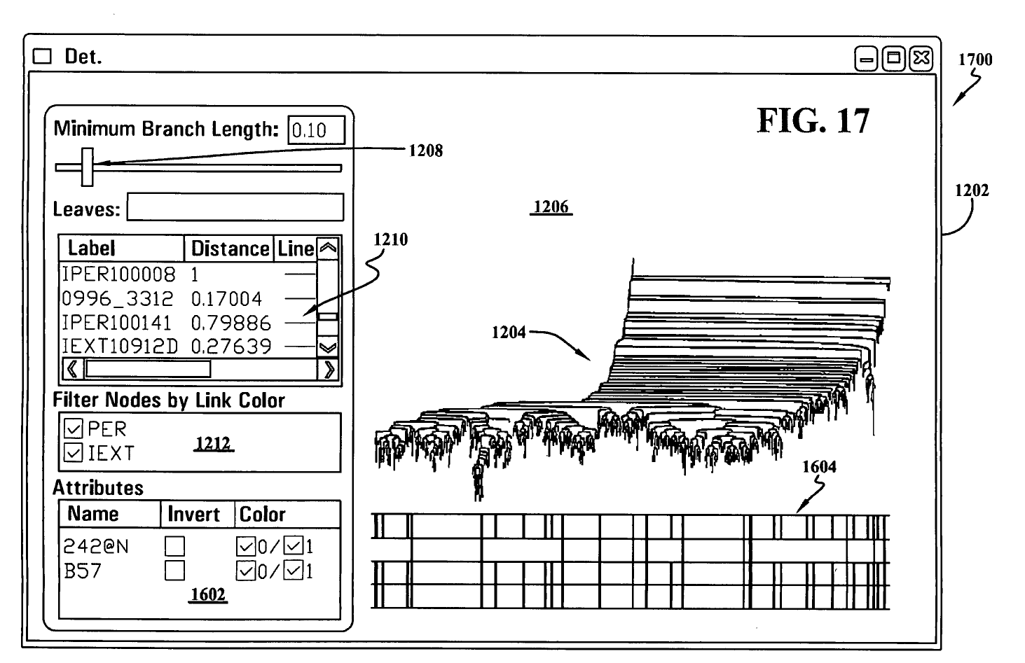

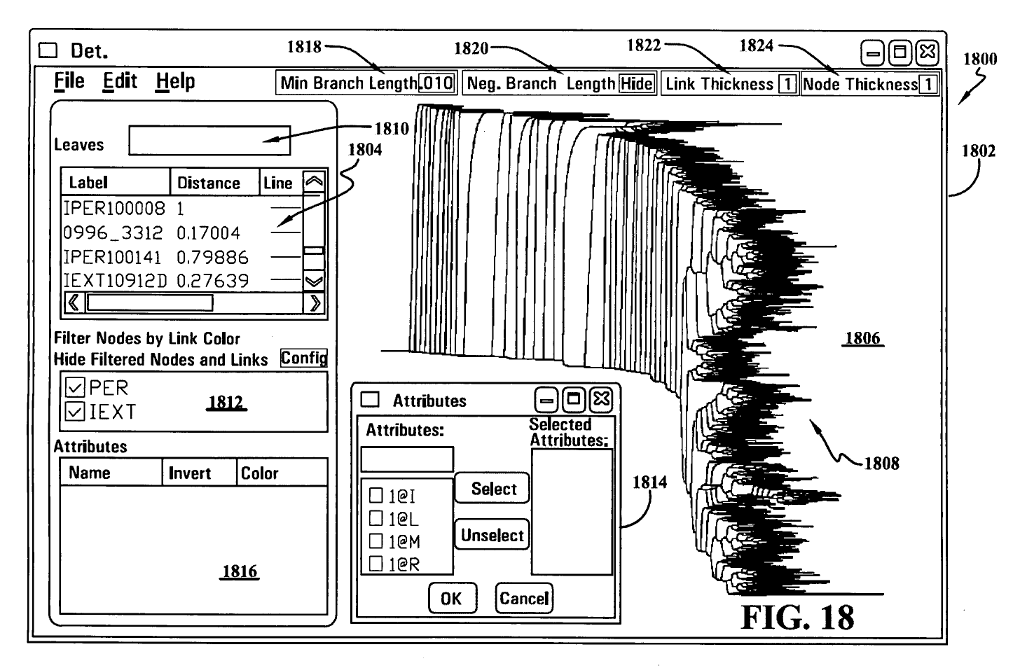

Turning now to FIG. 17, another screenshot 1700 of the example graphical user interface 1202 is depicted. In this example, particular values have been selected for attributes in the fourth field 1702. The tree structure 1204 can be rendered to indicate which nodes have one or more of the selected values for the attributes listed in the fourth field 1702. The color bar 1704 has also been rendered to reflect which nodes have particular values for the selected attributes.

With reference to FIG. 18, a screenshot 1800 of an example graphical user interface 1802 is illustrated. The graphical user interface 1802 includes a first field 1804 that includes a listing of data elements that may be represented by a tree structure. A second field 1806 may include a graphically rendered tree structure 1808 that is representative of the data elements listed in the first field 1804 and relationships therebetween. As shown, edges in the tree structure 1808 may be at least partially curved in nature to facilitate display of an aesthetically pleasing tree structure.

The graphical user interface 1802 may also include a search field 1810 that facilitates receiving queries for data elements listed in the first field 1804. A third field 1812 may depict values of an attribute that is common amongst the data elements in the first field 1804, and may further indicate colors that are assigned to such values in the tree structure 1808. A popup window 1814 can be used to select attributes that may be employed in connection with rendering a color bar. The popup window may be similar to that shown in FIG. 14. In this example graphical user interface 1802, it can be discerned that orientation of the tree structure 1808 has been altered when compared with the orientation of the tree structure 1204 as depicted in FIG. 12. It is thus to be understood that any suitable orientation of a tree structure is contemplated and intended to fall under the scope of the hereto-appended claims.

The graphical user interface 1802 may further include numerous fields 1818, 1820, 1822, and 1824 that can receive information pertaining to rendering the tree structure 1808 and/or a related color bar, including width of nodes displayed in the tree structure 1808, minimum length of edges in the tree structure 1808, width of edges in the tree structure 1808, and/or other information related to rendering the tree structure 1808. Additionally or alternatively, buttons may be included to facilitate receiving information from a user pertaining to rendering the tree structure 1808 and/or a color bar.

Referring now to FIG. 19, another screenshot 1900 of the graphical user interface 1802 is depicted. In the screenshot 1900, the fourth field 1816 includes a plurality of attributes and corresponding possible selected by way of the popup window 1814 (FIG. 18). Further, the second field 1806 includes a color bar 1902 that corresponds to the attributes and selected values in the fourth field 1816.

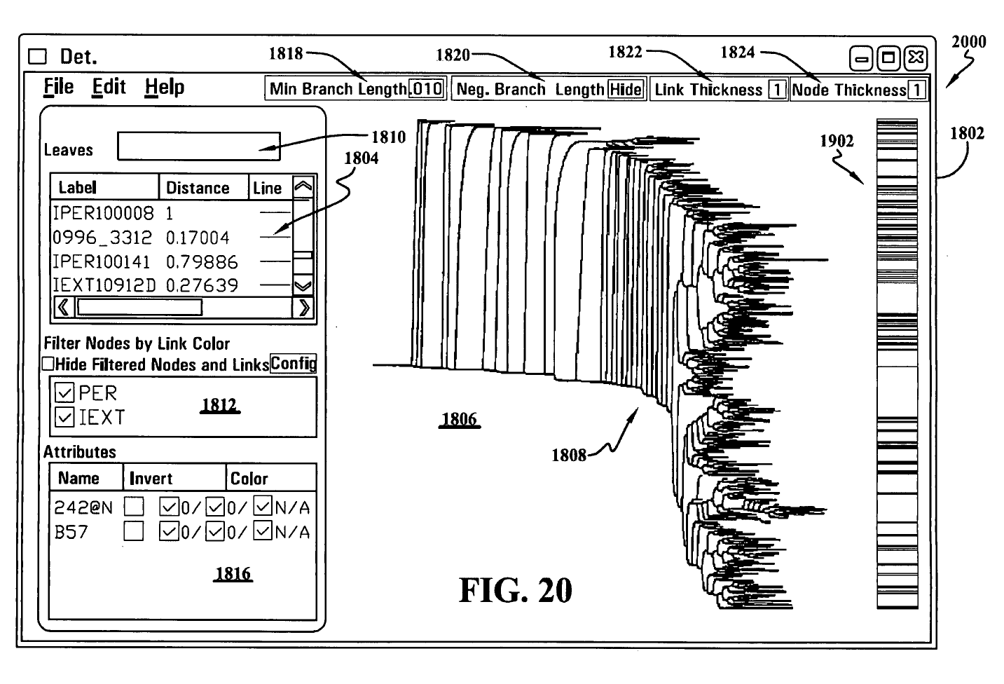

With reference to FIG. 20, another screenshot 2000 of the example graphical user interface 1802 is depicted. In the screenshot 2000, certain values of attributes have been selected in the fourth field 1816, which can cause the tree structure 1808 and the color bar 1902 to be re-rendered. In other words, the tree structure 1808 and the color bar 1902 have been filtered to depict data elements that have the selected values for the attributes listed in the fourth field 1816.

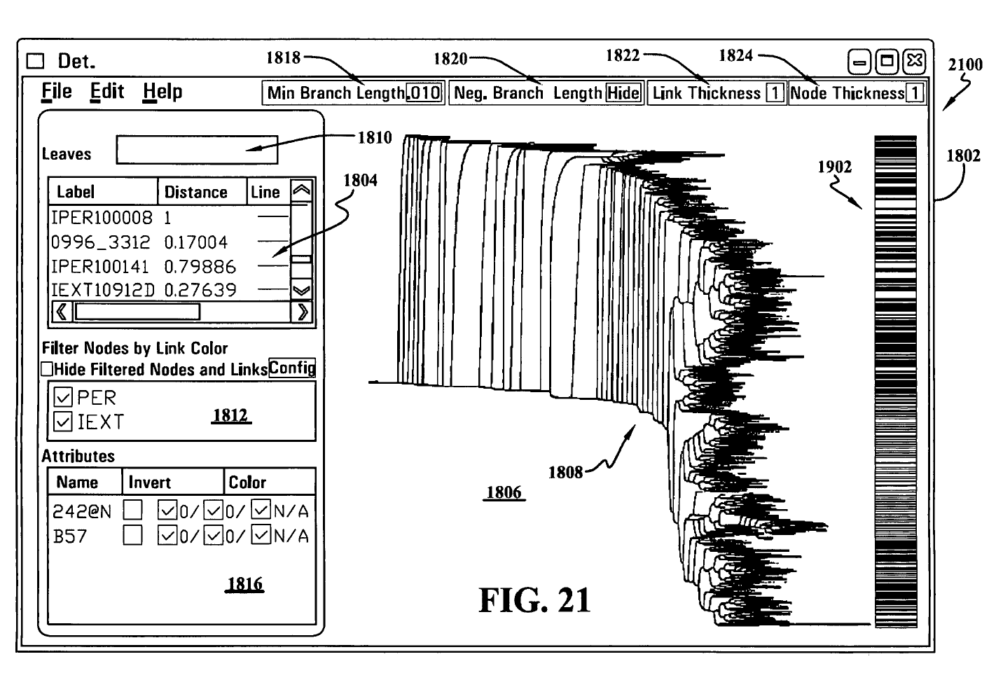

Turning now to FIG. 21, an example screenshot 2100 of the graphical user interface 1802 is illustrated. In this example, values of the common attribute in the third field 1812 have been selected. In other words, the tree structure 1808 and the color bar have been filtered based upon the selected value. For instance, nodes in the tree structure 1808 that correspond to a de-selected attribute value can be de-emphasized in the tree structure 1808 and/or color bar 1902.

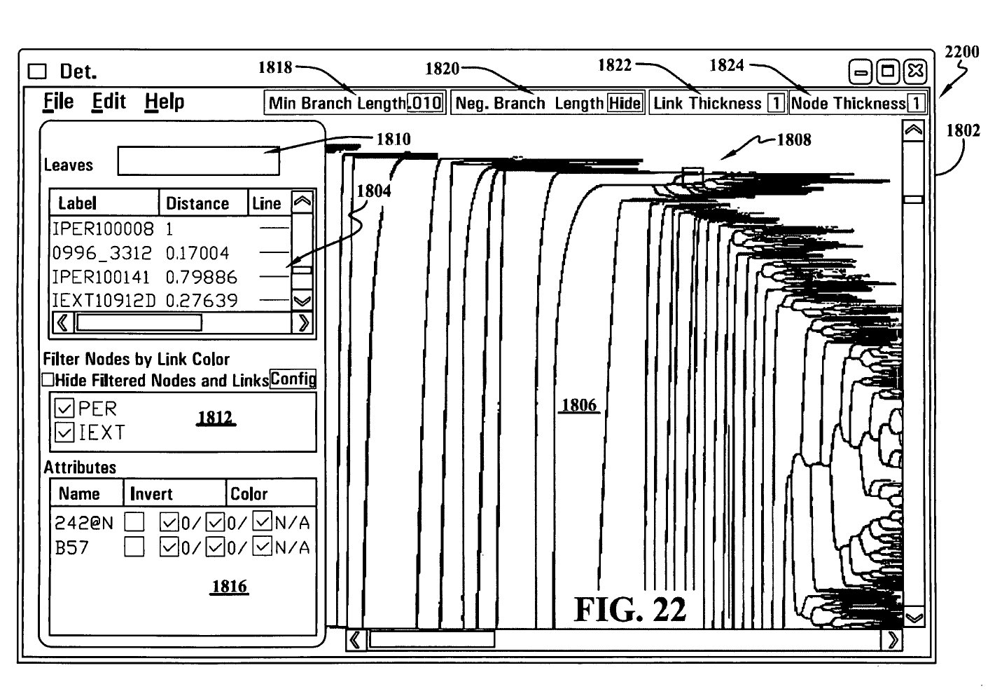

Referring now to FIG. 22, an example screenshot 2200 of the graphical user interface 1802 is depicted. In the example screenshot 2200, a user has selected a data element from the list of data elements in the first field 1804 (e.g., the user has selected a data element with a pointing and clicking mechanism). The graphical user interface 1802 can automatically emphasize a node in the tree structure 1808 that corresponds to the selected data element. For instance, a node may be emphasized by rendering the node as a square 2202 that can be visually differentiated from other nodes in the tree structure 1808. Further, a view of the tree structure 1808 can be automatically changed such that the second field 1806 provides a relatively close view of the node.

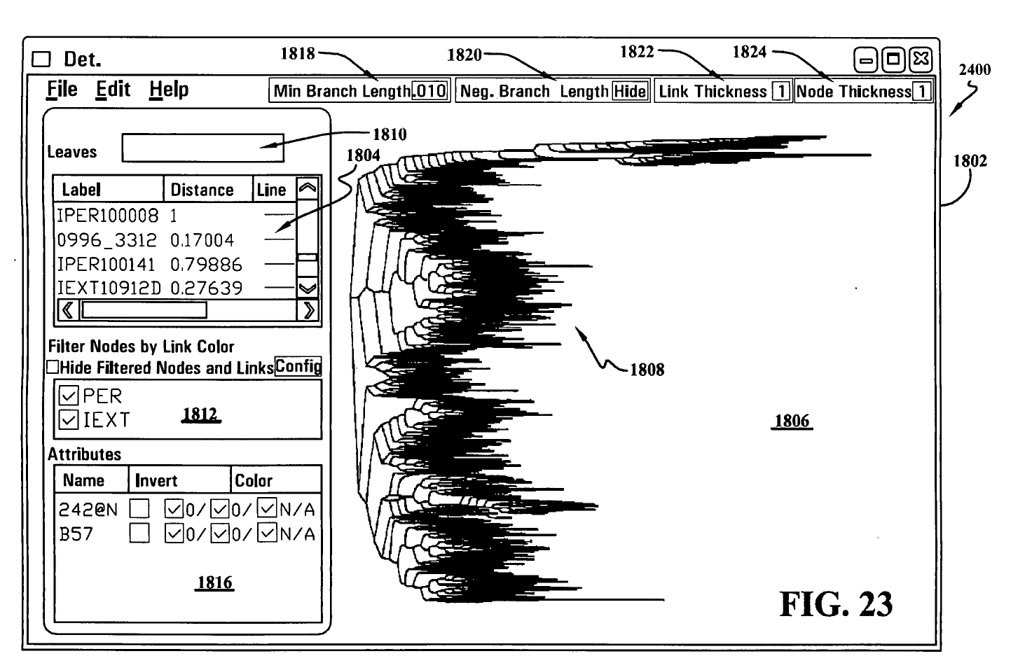

Now referring to FIG. 23, an example screenshot 2300 of the graphical user interface 1802 is illustrated. In the example screenshot 2300, the tree structure 1808 has been re-rendered with a user-selected node as a root node. More particularly, the screenshot 1800 illustrates the tree structure 1808 rendered with a first node as a root node. The screenshot 2200 illustrates user-selection of a node in the tree structure 1808 (e.g., by way of selecting a data element that is represented by the node). The screenshot 2300 illustrates re-rendering the tree structure 1808 with the selected node as the root node. Using different nodes as the root node can allow a user to view the tree structure 1808 at different perspectives.

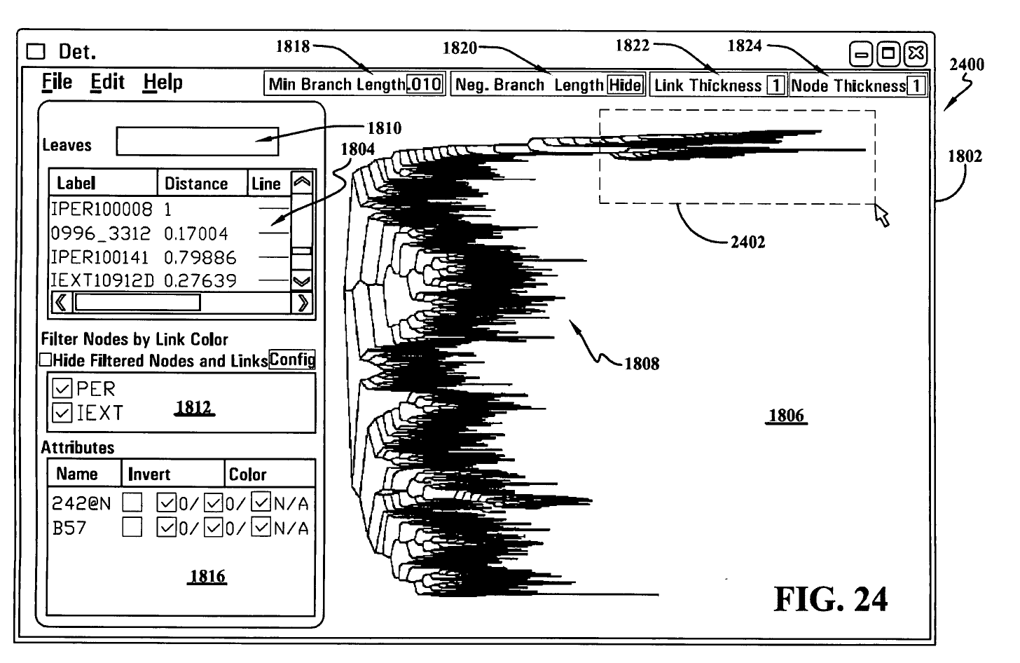

Turning briefly to FIG. 24, another example screenshot 2400 of the graphical user interface 1802 is illustrated. The screenshot 2400 depicts user selection of a region 2402 that includes a portion of the tree structure 1808 that is desirably displayed to a user in more detail (e.g., the user wishes to “zoom in” on the region 2402). A user can use a drag technique to create the region 2402, and may then select a command that causes the view to alter (e.g., right click followed by selection of a presented option).

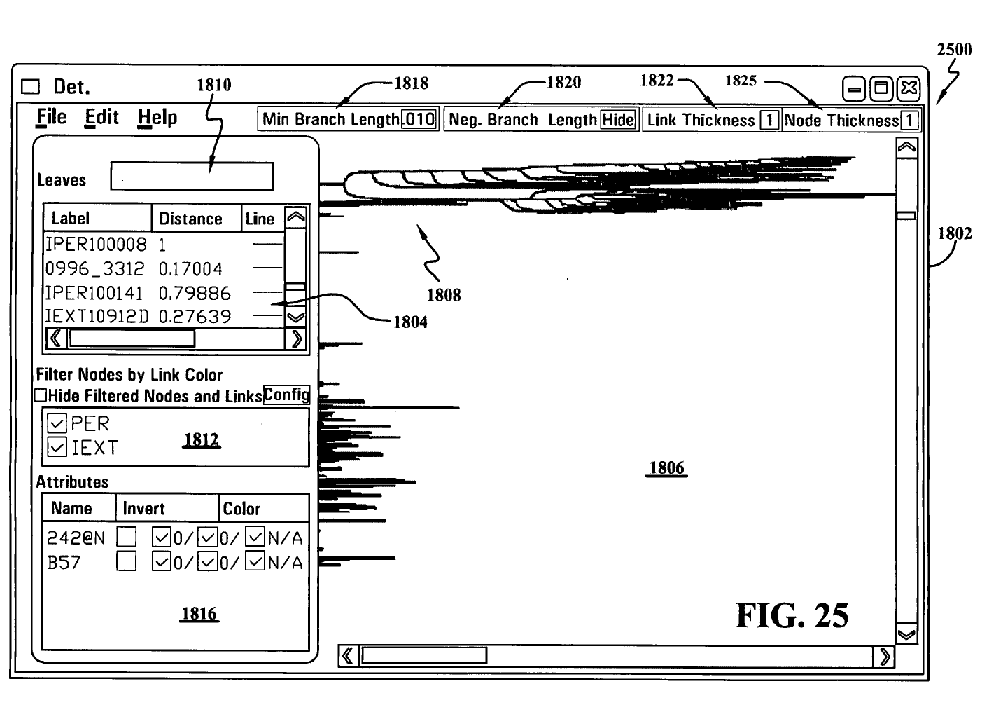

Referring to FIG. 25, yet another example screenshot 2500 of the graphical user interface 1802 is depicted. In the screenshot 2500, the region 2402 is shown after a zoom has occurred. Thus, more detail is shown pertaining to the region 2402 of the tree structure 1808.

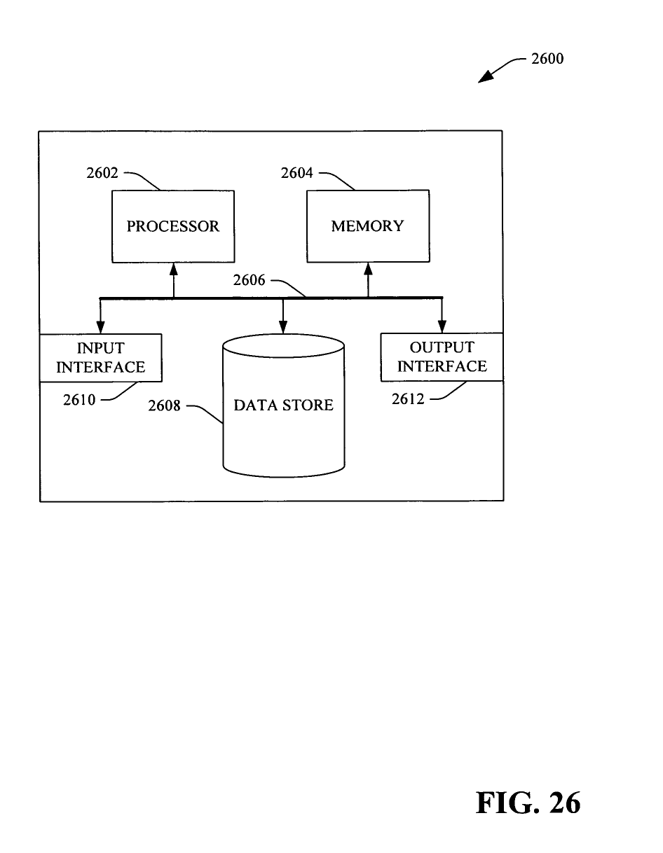

Now referring to FIG. 26, a high-level illustration of an example computing device 2600 that can be used in accordance with the systems and methodologies disclosed herein is illustrated. For instance, the computing device 2600 may be used in a system that supports graphically depicting a tree structure. The computing device 2600 includes at least one processor 2602 that executes instructions that are stored in a memory 2604. The instructions may be, for instance, instructions for implementing functionality described as being carried out by one or more components discussed above or instructions for implementing one or more of the methods described above. The processor 2602 may access the memory by way of a system bus 2606. In addition to storing executable instructions, the memory 2604 may also store data elements, including attributes, as well as user-defined instructions for filtering and viewing data.

The computing device 2600 additionally includes a data store 2608 that is accessible by the processor 2602 by way of the system bus 2606. The data store 2608 may include executable instructions, data elements, tree structures, etc. The computing device 2600 also includes an input interface 2610 that allows external devices to communicate with the computing device 2600. For instance, the input interface 2610 may be used to receive instructions from an external computer device, a user, etc. The computing device 2600 also includes an output interface 2612 that interfaces the computing device 500 with one or more external devices. For example, the computing device 2600 may display text, images, etc. by way of the output interface 512.

Additionally, while illustrated as a single system, it is to be understood that the computing device 2600 may be a distributed system. Thus, for instance, several devices may be in communication by way of a network connection and may collectively perform tasks described as being performed by the computing device 1200.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A method comprising the following computer-executable acts:
receiving data that includes several data elements, wherein the several data elements are related hierarchically, wherein each data element in the several data elements has a common attribute, and wherein each data element in the several data elements has a value for the common attribute;
assigning each of the data elements in the several data elements to one of a plurality of layers based at least in part upon the value of the common attribute for each of the data elements;
generating a tree structure that is representative of a hierarchy of the several data elements, wherein the tree structure includes nodes that represent the data elements and edges that represent relationships between the data elements, and wherein the edges correspond to the common attribute;
determining a length of each edge in the tree structure based at least in part upon which layers that data elements corresponding to edges are assigned; and
graphically depicting the tree structure, wherein the tree structure includes edges of determined lengths.

2. The method of claim 1, further comprising using the Sugiyama method in connection with assigning each of the data elements in the several data elements to one of the plurality of layers.

3. The method of claim 1, wherein the tree structure represents an evolutionary tree.

4. The method of claim 3, wherein the common attribute is time between evolutionary events.

5. The method of claim 4, further comprising:
receiving a selection from a user as to which data element is to be a root node; and
graphically depicting the tree structure with the selected data element as the root node and other data elements as children of the root node.

6. The method of claim 1, wherein a data element in the several data elements has a second attribute corresponding thereto, and further comprising displaying a node corresponding to the data element in a particular color based at least in part upon a value of the second attribute.

7. The method of claim 1, wherein the tree structure includes a plurality of leaf nodes, and further comprising:
individually assigning leaf nodes colors based at least in part upon values of a second common attribute of the leaf nodes;
generating a color bar that includes several rows, wherein a first row is indicative of locations of leaf nodes in the tree structure and is colored corresponding to the individually assigned colors of the leaf nodes.

8. The method of claim 7, further comprising:
receiving a selection of an attribute that corresponds to a subset of the leaf nodes; and
rendering a second row in the color bar to illustrate which of the leaf nodes have the selected attribute.

9. The method of claim 8, further comprising:
receiving selections of multiple attributes; and
rendering a row in the color bar that corresponds to each selected attribute.

10. The method of claim 7, further comprising:
receiving a selection of a third attribute; and
emphasizing leaf nodes in the tree structure that correspond to the selected third attribute.

11. The method of claim 7, further comprising shading portions of the color bar based at least in part upon whether leaf nodes overlap.

12. The method of claim 1, further comprising:
receiving a search for a data element; and
automatically displaying a portion of the tree structure to emphasize the data element.

13. A system that comprises the following computer-executable components:
a receiver component that receives multiple data elements, wherein each of the data elements has a common attribute and a value for the common attribute, and wherein the several data elements are hierarchically related;
an assignor component that independently assigns each of the multiple data elements to one of a plurality of layers, wherein a data element is assigned to a layer based at least in part upon the value of the common attribute that corresponds to the data element; and
a renderer component that receives assignments made by the assignor component and graphically renders a tree structure based at least in part upon the assignments, wherein the tree structure includes nodes that are representative of data elements and edges that are representative of relationships between data elements, and wherein length of an edge is based at least in part upon an assignment of a data element corresponding to the edge to a layer.

14. The system of claim 13, wherein the common attribute is time between evolutionary events corresponding to the data elements.

15. The system of claim 13, wherein the tree structure is one of an evolutionary tree and a probability tree.

16. The system of claim 13, further comprising an indicator component that receives a selection of a second attribute and indicates on the tree which nodes have the second attribute.

17. The system of claim 13, further comprising a re-renderer component that receives a selection of a node that is desirably a root node and re-renders the tree structure based at least in part upon the selection.

18. The system of claim 13, further comprising a color assignor component that assigns a color to nodes in the tree structure based at least in part upon values of attributes corresponding to the nodes.

19. The system of claim 18, wherein the color assignor component assigns a color to edges corresponding to the nodes based at least in part upon values of attributes corresponding to the nodes.

20. A graphical user interface, comprising:
a first field that displays a hierarchical tree structure, wherein the tree structure includes nodes that represent data elements and edges that represent relationships between data elements;
a second field that includes a listing of data elements that comprises a plurality of selectable data elements that are represented by nodes in the tree structure, wherein location of a node corresponding to the data element is indicated upon selection of the data element;
a third field that displays a plurality of possible values of an attribute of the data elements, wherein each of the possible values of the elements are selectable, and wherein selection of a possible value emphasizes nodes that correspond to data elements that have the possible value and de-selection of the possible value de-emphasizes nodes that correspond to data elements that have the possible value;
a fourth field that displays a plurality of attributes, wherein an attribute in the plurality of attributes corresponds to a subset of the data elements, and wherein each of the plurality of attributes are selectable; and
a fifth field that displays a color bar, wherein contents of the color bar are based at least in part upon which attributes in the plurality of attributes are selected.
